(19) United States
(12) Patent Application Publication
(10) Pub. No.: US 2010/0005127 A1
(43) Pub. Date: Jan. 7, 2010

(54) File operation apparatus

(75) Inventor: Kensuke Suzuki, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/458,047

(22) Filed: Jun. 30, 2009

(30) Foreign Application Priority Data
Jul. 2, 2008 (JP) 2008-173772

(51) Int. Cl. G06F 12/00; G06F 12/16

(52) U.S. Cl. 707/204; 707/200; 707/E17.01; 707/E17.044; 711/E12.001; 711/E12.103

(57) ABSTRACT

A file operation apparatus connectable with a storage medium is disclosed. The storage medium stores therein multiple files. Each file contains a category information item defining a prescribed category of the file. The prescribed categories of the multiple files are independent of a directory structure. The file operation apparatus includes: a category selection reception section configured to receive selection of a target category; an operation target selection section configured to identify one or more of the multiple files whose prescribed category matches the target category from the multiples file, and configured to select the identified one or more of the multiple files as operation target files; and a file operation section configured to perform a predetermined file operation on the operation target files.

### CROSS REFERENCE TO RELATED APPLICATION

The present application is based on Japanese Patent Applications No. 2008-173772 filed on Jul. 2, 2008, disclosure of which is incorporated herein by reference.

### BACKGROUND OF THE INVENTION

1. Field of the Invention

The present invention relates to a file operation apparatus adapted to perform a file operation such as deleting an electronic file from a storage medium, copying the electronic file from the storage medium to another storage medium, and the like.

2. Description of Related Art

There is known a record play apparatus connectable with a portable storage medium storing an electric file such as a music file, a video file and the like. The record play apparatus reads the electronic file from the storage medium and records the electronic file in mass storage media. In accordance with needs, the record play apparatus reads the electric file from the mass storage media, and plays sound or video.

The record play apparatus typically allows various types of file operation, such as recording a file in a storage medium, moving or copying a file from one storage medium to another storage medium, deleting a file and the like. Further, some record play apparatuses can perform a bulk file operation, which is a file operation collectively performed on multiple files. A typical way to perform a bulk file operation on multiple files is to display information about a directory structure (i.e., folder structure) and to select a directory containing bulk operation target files. Note that the directory structure indicates locations of files on a storage medium.

In some cases, however, a user fails to well-organize files by using directories. In such a cases, when a bulk file operation such as a bulk forward operation is performed on one directory containing multiple files, the forwarded files may include a file that a user did not intend to forward.

If bulk operation target files are distributed in multiple directories, a complicated procedure is required. For example, in order to select the bulk operation target files, it is required to display multiple lists each showing files in one directory, and it is required to search the multiple lists for the bulk operation target files.

Japanese Unexamined Utility Model Application Publication H4-40343 discloses a technique for addressing the above described difficulty. According to the technique, a group file table is made by grouping file names, so that it becomes possible to perform a bulk operation on a group of files independently of a directory structure.

According to the technique disclosed in Japanese Unexamined Utility Model Application Publication H4-40343, however, it is necessary to make a group file table for user-by-user, and an amount of content of the group file table becomes enormous when the number of files is large. Thus, there arises a difficulty that the making of a group file table becomes a complicated procedure for a user.

### SUMMARY OF THE INVENTION

In view of the above and other difficulties, it is an objective of the present invention to provide a file operation apparatus that enables a file operation on multiple files with high operability.

According to an aspect of the present invention, a file operation apparatus for performing a predetermined file operation on a storage medium is provided. The storage medium stores therein multiple files. The storage medium has a data area and a management area. The data area stores therein a real data of each of the multiple files. The management area stores therein information about a directory structure for organizing the multiple files. The management area further stores therein file management information. The real data of each of the multiple files contains a category information item defining a prescribed category of the each of the multiple files. The prescribed category of each of the multiple files is independent of the directory structure. The file operation apparatus includes: a category selection reception section configured to receive selection of a target category from a user; an operation target selection section configured to identify one or more of the multiple files whose prescribed category matches the target category from the multiples files based on the real data of each of the multiple files, and configured to select the identified one or more of the multiple files as operation target files; and a file operation section configured to perform the predetermined file operation on the operation target files.

According to the above file operation apparatus, it is possible to enable a bulk file operation on multiple files with high operability. For example, it becomes possible to collectively select files belonging to a target category as a target for a bulk file operation such as file recording, moving, deleting, executing and the like, regardless of locations of the files in a directory structure.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram illustrating a HDD music server in accordance with one embodiment;

FIG. 2 is a diagram illustrating a volume structure of CD-ROM;

FIG. 3 is a flowchart illustrating a category list making processing;

FIG. 4A is a diagram illustrating multiple files stored in a storage medium;

FIG. 4B is a diagram illustrating a category list in which files are classified according to categories;

FIG. 5 is a flowchart illustrating a file record processing;

FIG. 6 is a diagram illustrating exemplary screens to be displayed in the file record processing; and

FIG. 7 is a flowchart illustrating a category bulk record procedure.

### DETAILED DESCRIPTION OF THE EXEMPLARY EMBODIMENTS

Exemplary embodiments are described below with reference to the accompanying drawings.

[Configuration of HDD Music Server]

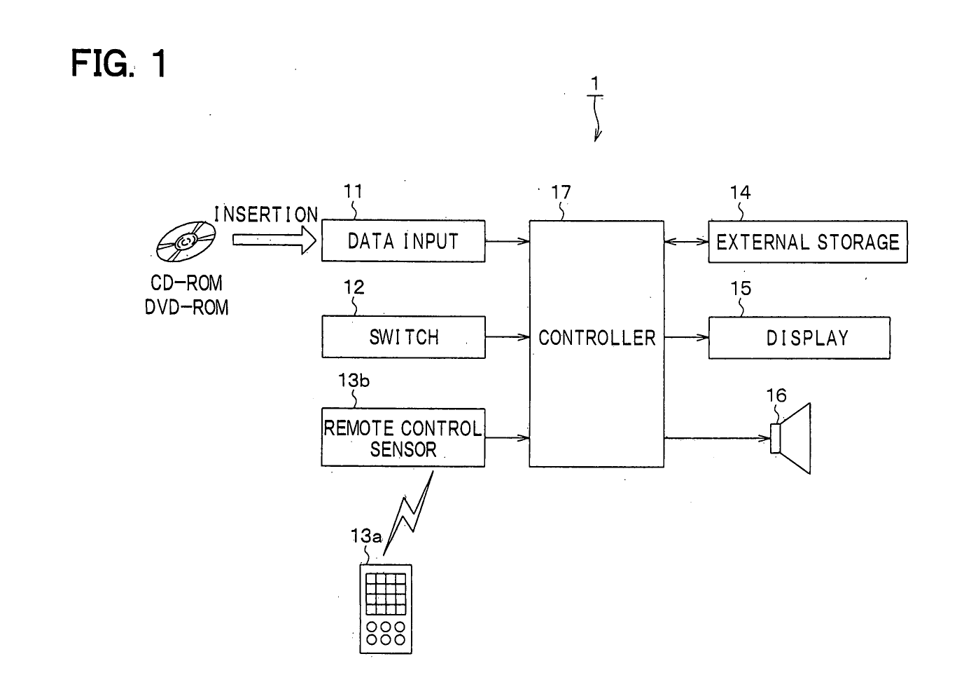

FIG. 1 is a block diagram illustrating a HDD music server 1 according to one embodiment.

As shown in FIG. 1, the HDD music server 1 includes a data input device 11, a group of switches 12, a remote control terminal 13a (referred to hereinafter as a remote controller), a remote controller sensor 13b, a storage device 14, a display device 15, a speaker 16, and a controller 17 connected with the foregoing components. The data input device 11 reads data from a storage medium that stores information about music, video or the like. The group of switches 12 enables a user to input a variety of instructions. The remote controller 13a also enables a user to input a variety of instructions. The remote controller sensor 13b receives an input signal from the remote controller 13a. The storage device 14 can store therein the data read via the data input device 11, so that the stored data can be readable. The display device 15 displays a variety of images. The speaker 16 outputs various audio guidance, music and the like. The controller 17 performs various control processing. The HDD music server 1 plays video or music based on a file read via the data input device 11, the storage device 14 or the like. In the above, the storage device 14 may be an internal storage device 14 of the HDD music server 1. Alternatively, the storage device 14 may be an external component of the HDD music server 1, and may be called an external storage device 14.

The data input device 11 has a slot. A portable storage medium such as CD-ROM, DVD-ROM and the like can be inserted into the slot. The data input device 11 reads data, such as a music file, video file and the like, from the storage medium inserted in the slot. The data input device 11 may further or alternatively have an interface for establishing connection with, for example, a portable CD/DVD player. Such interface may be USB (Universal Serial Bus) for instance.

The group of switches 12 is provided by, for example, a touch-sensitive panel or mechanical key switches. The touch-sensitive panel may be integrated with the display device 15 so that the group of switches 12 is arranged on a display screen of the display device 15. The mechanical key switches may be arranged in a periphery of the display device 15. The storage device 14 includes, for example, a rewritable non-volatile storage device such as a HDD, a memory card, and the like.

The display device 15 is, for example, a color display device with a liquid crystal display, an organic electroluminescence (EL) display or the like. The display device 15 can display various images such as a window for music server operation, a video and the like. The controller 17 includes a CPU, ROM, RAM, I/O, and a bus line connecting the foregoing components. The controller 17 may mainly provided by a known microcomputer. The controller 17 controls the above described and other components of the HDD music server 1. The controller 17 performs various processing in accordance with programs stored in the ROM, the storage device 14 or the like.

For example, the controller 17 performs a music server relating processing in accordance with an instruction inputted via the group of switches 12. The music server relating processing includes: recording or copying a music file from the storage medium such as CD-ROM and DVD-ROM to the storage device 14; and performing a file operation on the music file stored in the storage device 14. The file operation is, for example, playing the music file, copying a file to another storage medium, deleting a file and the like. In the above processing, from a large number of files stored in the storage device 14, the controller 17 extracts a file or files classified as file with a user-specified category by utilizing a tag data (i.e., tag information) contained in each of the files. The controller 17 selects the extracted files as operation target files, and performs a user-instructing bulk file operation on the selected operation target files. It should be noted that the tag data includes category information representing category of file. The category can be assigned to every attribute of the file. For a music file, the category of “classic”, “jazz” or the like may be assigned to the attribute of “genre”. The attribute of music file may be “genre”, “album”, “artist”, “track tile” or the like for instance. A flow of the above-described processing will be more specifically described later.

[Data Structure of Storage Medium]

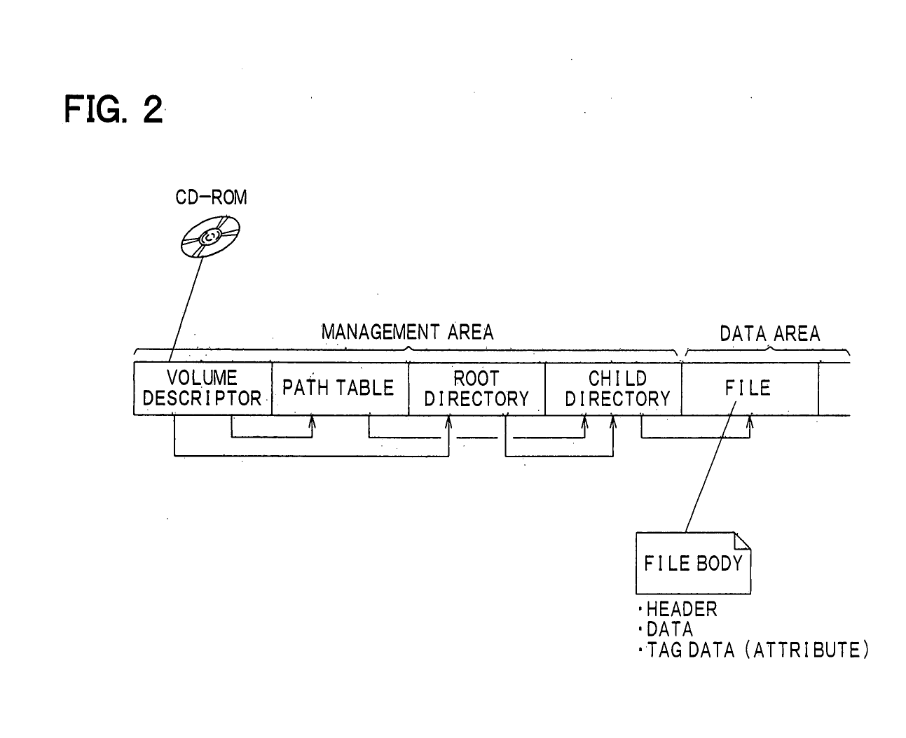

In accordance with one embodiment, FIG. 2 illustrates a schematic structure of a logical volume (i.e., volume) of a CD-ROM acting as a storage medium, from which the data input device 11 reads data.

As shown in FIG. 2, the volume of the CD-ROM has a management area, in which file management information is described, and a data area, which stores real data of files. The files belong to directories. The management area contains a volume descriptor, a path table, a root directory, a child directory, and the like.

The volume descriptor describes basic information on the volume, including an attribute of the volume, a location of the root directory, a location of the path table and the like. The path table can function as a search table indicative of all of the directories including the root directory and the child directories in the volume, and can be utilized for high-speed directory search.

The root directory is the uppermost directory in a tree-type hierarchical directory structure. The child directories are a group of subdirectories located lower than the root directory, and every child directory belongs to a directory. Each directory has information about a file and a subdirectory contained in the each directory, such as a file identifier and a directory identifier.

In access to a file in the volume of the above-configured CD-ROM, it is possible to perform quick search for a target file by referring to the path table to specify the directory containing the target file.

A file entity stored in the data area includes a header located at the beginning of a file, a data body of the file, and a tag data (i.e., tag information) being additional information which defines the attribute and the category of the file. For example, the tag data of a music file defines the attribute of the music file. The attribute is for example as “genre”, “album”, “artist”, and “tack tile”, or the like. One or more attributes may be assigned to one file. Further, the tag data defines a value (i.e., category) assigned to attribute by attribute.

[Operation of HDD Music Server]

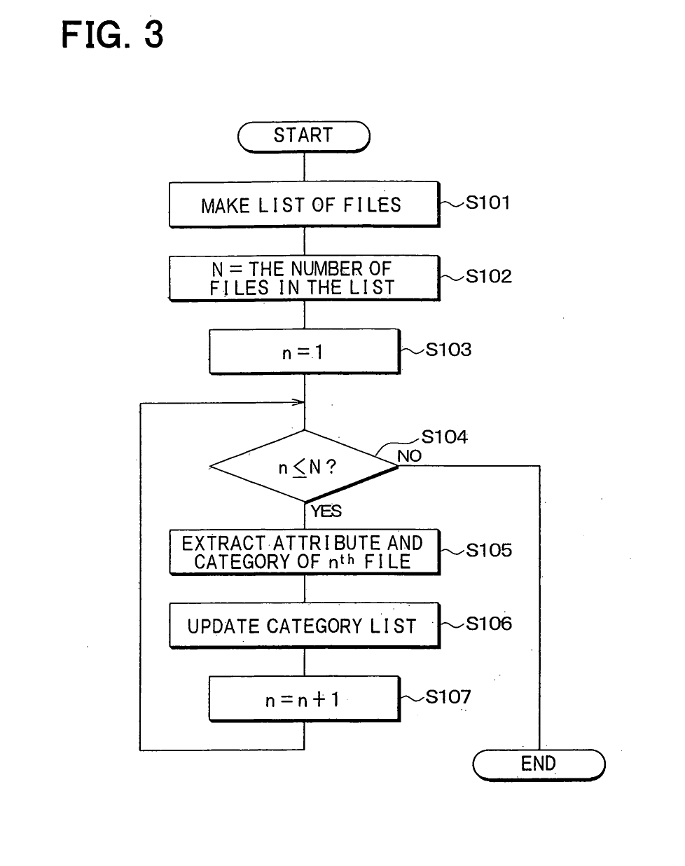

Referring to FIGS. 3 to 7, operation of the HDD music server 1 is described below in accordance with to one embodiment.

FIG. 3 is a flow chart illustrating a category list making processing that the controller 17 of the HDD music server 1 executes. When a storage medium acting as a data reading target, e.g., CD-ROM, is connected to the data input device 11, the controller 17 executes the category list making processing.

At S101, the controller 17 refers to a group of files stored in the storage medium, and makes a list of files so that the list contains all of the files that can be a control target for operation of the HDD music server 1. At 102, the controller 17 sets “N” to the total number of files in the list.

At S103, the controller 17 sets a counter value “n” to “1”. At S104, the controller 17 determines whether the counter value “n” is less than or equal to the total number of the files “N”. When the counter value “n” is determined to be less than or equal to the total number of files “N”, corresponding to “YES” at S104, the processing proceeds to S105. At S105, the controller 17 refers to the storage medium for a file that corresponds to the n^{th} file in the list, and the controller 17 extracts the category information and the attribute of the n^{th} file from the tag data of the n^{th} file. At S106, the controller 106 updates a category list by adding the extracted attribute and category information to the category list. The category list classifies files according to attributes, so that categories and file names of the files are classified according to the attributes. The attributes for classification are contained in tag data of the files. The category is indicated by a value assigned to each attribute.

At S107, the controller 17 increases the counter value “n” by 1, and the processing returns to S104. Then, the controller 17 repeatedly and successively performs S104 to S107, thereby successively extracting the attribute and category information of the files in the list. When the counter value “n” is determined to be greater than or equal to the total number of files “N”, corresponding to “NO” at S104, the category list making processing is ended.

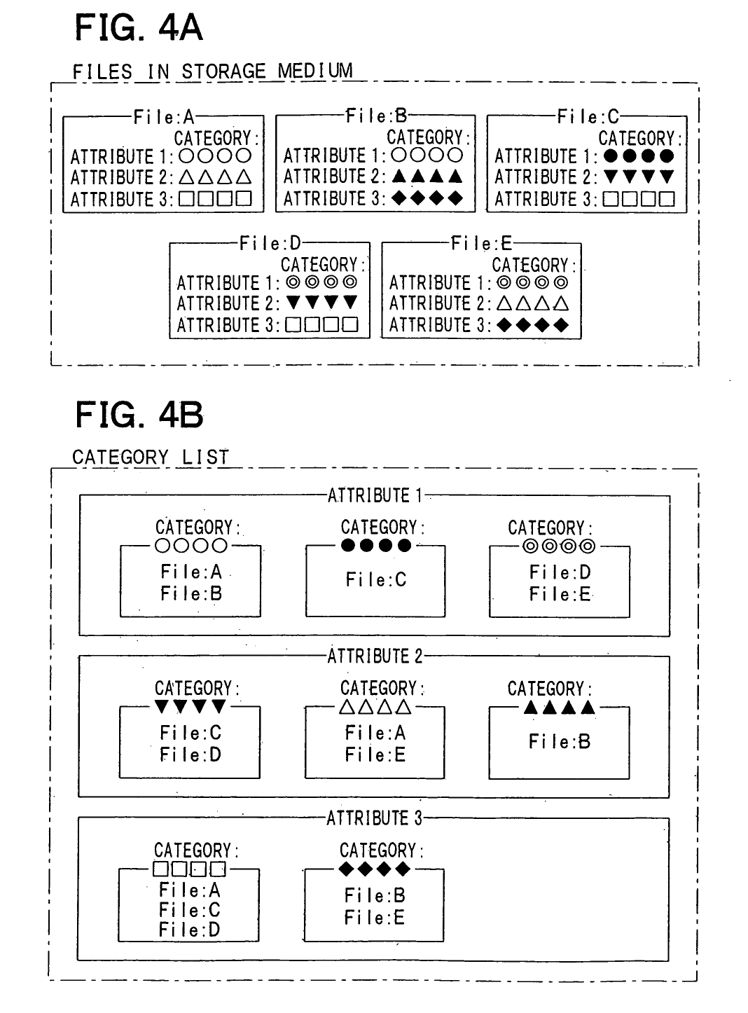

FIG. 4A is a diagram illustrating multiple files stored in a storage medium. FIG. 4B is a diagram illustrating a category list made by the file classification. As shown in FIG. 4A, the files A, B, C, D and E are stored in the storage medium. A Variety of values each indicating a certain category is assigned to each of attributes 1, 2 and 3. When the files stored in the storage medium are assumed to be music files for instance, each music file includes category information specifying a category assigned on a attribute by attribute basis. The attribute is for example “genre”, “album”, “artist” and the like. The category assigned to the attribute “genre” is for example “Classic”, “Jazz”, “Rock” or the like. In the above described category list making processing (see FIG. 3), the tag data is extracted from each of the files, and the files are classified according to attributes and categories.

FIG. 4B illustrates one example of the category list that is made from the files shown in FIG. 4A. As shown in FIG. 4B, categories each assigned to a certain attribute are classified according to attributes, which are first to third attributes 1 to 3 in this example. Further, the files are classified according to categories so that a file or files belonging to one category forms one group of files.

More specifically, as shown in FIG. 4B, the categories “◯◯◯◯”, “”, and “⊚⊚⊚⊚” are classified as categories that corresponds to the first attribute. The files A and B are classified as files that belong to a category “◯◯◯◯”. The file C is classified as a file that belongs to a category “”. The files D and E are classified as files that belong to a category “⊚⊚⊚⊚”. The categories “▾▾▾▾” “ΔΔΔΔ”, and “▴▴▴▴” are classified as categories that corresponds to the second attribute. The files C and D are classified as files that belong to a category “▾▾▾▾”. The files A and E are classified as files that belong to a category “ΔΔΔΔ”. The file B is classified as a file that belongs to a category “▴▴▴▴”. The categories “□□□□” and “♦♦♦♦” are classified as categories that corresponds to the third attribute. The files A, C and D are classified as files that belong to a category “□□□□”. The files B and E are classified as files that belong to a category “♦♦♦♦”.

A value of the attribute, which indicates a category, may be arbitrary. Values that can be determined to indicate the same category may be grouped. Further, although the substantially same characters may be represented in different ways or different values between different character encoding systems, the HDD music server 1 may treat such differently-represented-characters as the same characters.

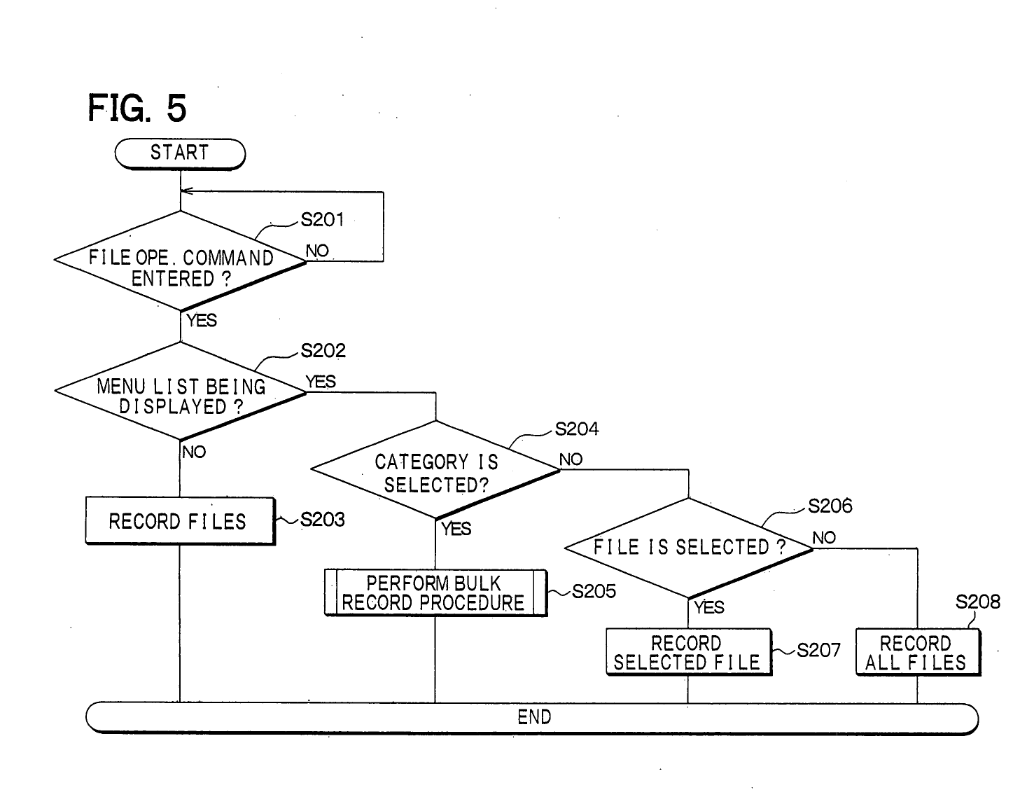

FIG. 5 is a flowchart illustrating a file record processing, which is executed by the controller 17 to perform one type of file operations. Through the file record processing, the desired file, which is one or more of all of the files stored in the storage medium, can be recorded in another storage medium. It should be noted that the below described explanation on the file record processing is directed to one exemplary case, where multiple files are read from the storage medium such as CD-ROM connected with the date input device 11 and the multiple files are recorded in the storage device 14.

As shown in FIG. 5, at S201, the controller 17 determines whether an instruction for file record is inputted via the group of switches 12 or the remote controller 13a. When it is determined that the instruction for file record is inputted, corresponding to “YES” at S201, the processing proceeds to S202. At S202, the controller 17 determines whether the display device 15 did display a menu list at the time of the input of the instruction for file record.

In one embodiment, the menu list is provided by a Graphic User Interface (GUI) window. The GUI window contains selectable items, including: an operation menu for operation of the HDD music sever 1; multiple items associated with attributes and categories extracted in the above described category list making processing; items associated with the files; and the like. The GUI enables a user to operate a cursor to move to and point a user desiring selectable item on the GUI window. Further, when a user performs a predetermined determination or selection operation with the cursor pointing the selectable item, the controller 17 executes a function associated with the selectable item.

When the controller 17 determines that the display device 15 did not display the menu list at the time of the entry of the instruction for file record, corresponding to “NO” at S203, the processing proceeds to S203. At S203, from the storage medium (e.g., CD-ROM), the controller 17 reads the files that are set as the control target, and the controller 17 records the read files in the storage device 14, and, the file record processing is ended.

When the controller 17 determines that the display device 15 did display the menu list at the time of the entry of the instruction for file record, corresponding to “YES” at S203, the processing proceeds to S204. At S204, the controller 17 determines whether the selectable item selected by a user corresponds to category of file. When it is determined that the selected selectable item corresponds to the category of file, corresponding to “YES” at S204, the processing proceeds to S205. At S205, the controller 17 performs a category bulk record procedure. In the category bulk record procedure, the controller 17 specifies a group of files that belongs to the selected category by using the category list (see FIG. 4B), and the controller 17 reads the group of files from the storage medium (e.g., CD-ROM), and records the group of files in the storage device 14. Details of the category bulk record procedure will be described later.

When it is determined that the selected selectable item does correspond to the category of file, corresponding to “NO” at S204, the processing proceeds to S206. At S206, the controller 17 determines whether the selected selectable item in the menu list corresponds to a file name. When it is determined that the selected selectable item corresponds to a file name, corresponding to “YES” at S206, the processing proceeds to S207. At S207, the controller 17 reads a file that corresponds to the selected selectable item from the storage medium (e.g., CD-ROM) and records the read file in the storage device 14.

When it is determined that the selected selectable item does not correspond to a file name, corresponding to “NO” at S206, the processing proceeds to S208. At S208, the controller 17 reads all of the files stored in the storage medium (CD-ROM) and records all of the files in the storage device 14, and the file record processing is ended.

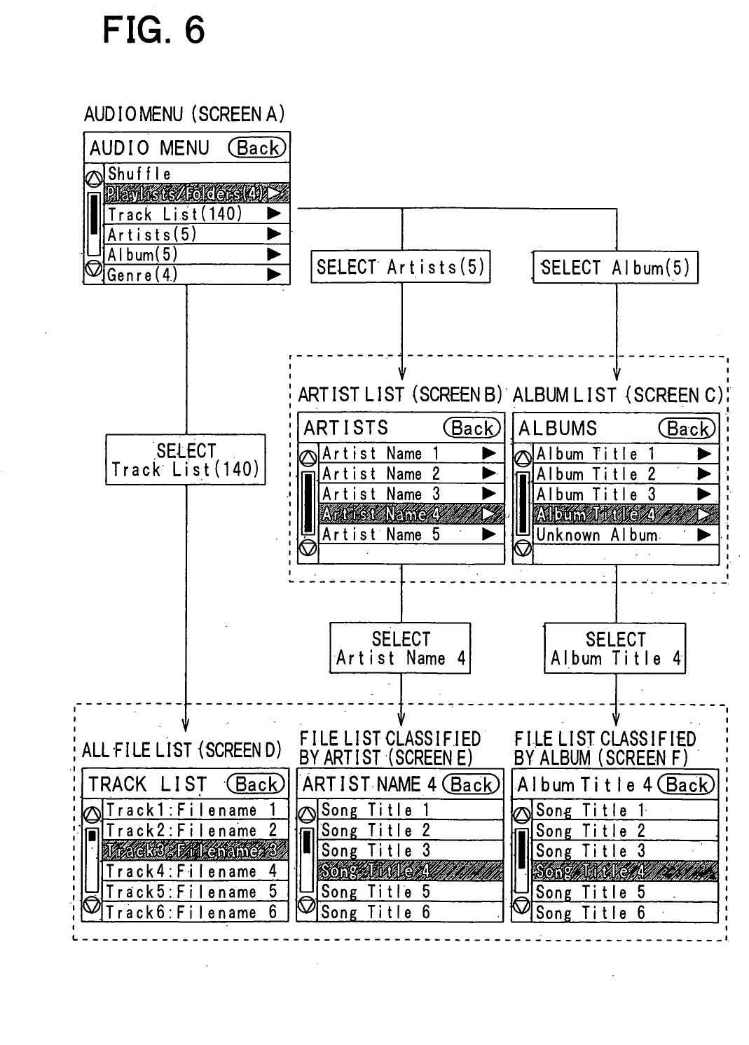

FIG. 6 is a diagram illustrating exemplary screens of the menu list that are displayed in the file record processing. A menu list system is hierarchically structured. The screen “A” illustrated in FIG. 6 is an example of an audio menu screen “TOP screen”, which is the uppermost screen in the menu list system. The audio menu screen contains selectable items including: “Shuffle” for randomly playing music files stored in a storage medium such as CD-ROM and the like; “Play list/Folders” for displaying a play list or a folder edited by a user; “Track list” for displaying a list of music file stored in the storage medium; “Artist” for displaying a list of artists in music files stored in the storage medium; “Album” for displaying a list of albums in music files stored in the storage medium; and “Genre” for displaying a list of genres in music files stored in the storage medium.

Among the selectable items on the audio menu screen, the selectable items “Artist”, “Album” and “Genre” respectively correspond to attributes contained in the category list (see FIG. 4B) made in the category list making processing (see FIG. 3). A figure in parenthesis of each selectable item indicates the number of elements belonging to the selectable item. When all of the selectable items cannot displayed within one screen, the list can be scrolled by operating a scroll bar located at a left end part of the screen.

When a user operates a high-lightened cursor to point the selectable item “Track LIST” on the audio menu screen “A” and performs a selection operation (referred to also as “select” for simplicity), the display is switched into a screen D, as shown in FIG. 6. In the screen D, the display device 15 displays a menu window containing a list of all files stored in the disk of the storage medium.

When a user operates the cursor to point the selectable item “Artist” on the audio menu screen A and selects the selectable item “Artist”, the display is switched into a screen B, as shown in FIG. 6. In the screen B, the display device 15 displays a menu window containing a list of categories that are classified in the attribute “Artist” in the category list. When a user points and selects an item “Artist Name 4” for instance, the display is switched into the screen E, as shown in FIG. 6. In the screen E, the display device 15 displays a menu window containing a list of files that are classified in the category “Artist Name 4” in the category list.

When a user operates the cursor to point the selectable item “Album” and selects “Album”, the display is switched into a screen C (see FIG. 6). In the screen C, the display device 15 displays a menu window containing a list of albums that are classified in the attribute “Album” in the category list. When the user further operates the cursor to point a selectable item “Album Title 4” and selects “Album Title 4”, the display is switched into a screen F, as shown in FIG. 6. In the screen F, the display device 15 displays a menu window containing a list of files that are classified in a category “Album Title 4”.

As seen above, the screens A to F are hierarchically structured in accordance with contents of the screens A to F. For example, when an information item associated with an attribute in the category list is selected on the TOP screen A, the display device 15 displays the screen B or C containing the list of categories that are classified in the selected attribute. When a selectable item corresponding to a certain category is selected on the screen B or C, the display device 15 displays the screen E or F containing a list of files that are classified in the selected category.

When the display device 15 displays the screen B or C for the menu window containing a list of categories, a user can operate the cursor to point a selectable item associated with a desired category and can perform an operation for a bulk file record instruction. Thereby, out of all files stored in the storage medium, a use can collectively select files that belong to the category associated with the selectable item and can collectively set the selected files as record target files.

When the display device 15 displays the screen D, E or F providing a list of files, a user can operate the cursor to point a selectable item associated with a desired file and can perform an operation for a file record instruction. Thereby, a user can individually select and set one file as a record target file.

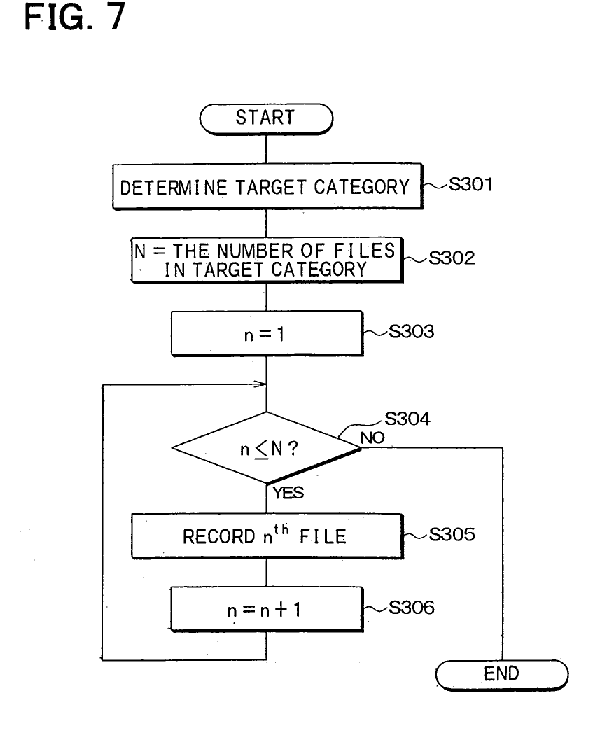

The category bulk record procedure executed by the controller 17 of the HDD music server 1 is described below with reference to FIG. 7. It should be noted that the category bulk record procedure corresponds to S205 of the file record processing (see FIG. 5).

At S301, the controller 17 determines a category directed to a file record operation. The category directed to a file record operation is also referred to a target category. According to one embodiment, the target category is selected via pointing and selecting a selectable item in the list of categories on the menu screen B, C (see FIG. 6).

At S302, based on the category list (see FIG. 4B), the controller 17 sets “N” to the number of files that belong to the target category. At S303, the controller 17 sets a counter value “n” to “1”. At S304, the controller 17 determines whether the counter value “n” is less than or equal to the number of the files “N”. When it is determined that the counter value “n” is less than or equal to the number of files “N”, corresponding to “YES” at S304, the procedure proceeds to S305. At S305, from the storage medium, the controller 17 reads a file that corresponds to the nth file in the files belonging to the target category in the category list, and the controller 17 stores the read file in the storage device 14. In the above, to specify a location of the file on the storage medium, the controller 17 utilizes the management information stored in the management area of the storage medium

At S306, the controller 17 increases the counter value “n” by 1, and the processing returns to S304. Then, the controller 17 repeatedly and successively performs S304 to S306, thereby successively recording the files belonging to the target category in the storage device 14. When the counter value “n” is determined to be greater than or equal to the total number of the files “N”, corresponding to NO at S304, the category bulk record procedure is ended. [ [symbol] : [symbol] [symbol] [symbol] ]

According to the above embodiment, the HDD music sever 1 can function as a file operation apparatus. The controller 17 performing S301 of the category bulk record procedure can function as a category selection reception means or section. The controller 17 performing S204 or S206 of the file record processing can function as an operation target selection means or section. The controller 17 performing S203, S205, S207 or S208 of the file record processing can function as a file operation means or section. The controller 17 performing S101 to S107 of the category list making processing can function as a list making means or section. The display device 15 displaying the screen A to F of the menu list can function as a list information providing section or means.

(Advantages)

Advantages of the HDD music server 1 according to one embodiment include the followings.

(1) It is possible to collectively select multiple files belonging to a user desired category and possible to collectively set the multiple files as a target for a file operation such as file record, file move, file delete, file execution, file play and the like, regardless of locations of the files in a directory structure. Accordingly, it is possible to save the effort of performing a complicated procedure, which may include: opening directories and displaying groups of files, each group belonging one directory; searching the groups of files for desired files; and selecting the desired files as file operation target files. Therefore, according to the present embodiment, it is possible to collectively select file operation target files through a simple operation of specifying a desired category only.

(2) The HDD music sever 1 enables a user to select a selectable item associated with a desired category from among selectable items in a menu list. Accordingly, a user can issue an instruction to (i) select multiple files belonging to the target category as an operation target and (ii) execute a bulk file operation on the multiple files, by selecting the selectable item associated with a desired category only. It is thus possible to improve operability.

(3) It is possible to provide a user with information about categories of files on an attribute-by-attribute-basis. It is thus possible to improve convenience for a user to select a category.

(Modifications)

The above described embodiment can be modified in various ways, examples of which are described below.

In the above embodiments, the HDD music sever 1 is illustrated as one example of a file operation apparatus. However, a file operation apparatus other than a music server can be embodiments of the present invention.

In the above embodiment, the file record processing (see FIG. 5) and the category bulk record procedure (see FIG. 7) are described as one example of processing associated with a file operation. According to the example processing and procedure, the files stored in a storage medium connected to the data input device 11 are copied to the storage device 14. A file selection manner for selecting files as an operation target illustrated in the above processing and procedure is applicable to various file operations such as movement, delete, execution and play on files stored in the storage device 14 or the like.

(Aspects)

The above embodiments and modifications have the following aspects.

According to an aspect, a file operation apparatus for performing a predetermined file operation on a storage medium is provided. The storage medium stores therein multiple files, and has a data area and a management area. The data area stores therein a real data of each of the multiple files. The management area stores therein information about a directory structure for organizing the multiple files. The management area further stores therein file management information. The real data of each of the multiple files contains a category information item defining a prescribed category of the each of the multiple files. The prescribed category of each of the multiple files is independent of the directory structure. The file operation apparatus includes: a category selection reception section configured to receive selection of a target category from a user; an operation target selection section configured to identify one or more of the multiple files whose prescribed category matches the target category from the multiples files based on the real data of each of the multiple files, and configured to select the identified one or more of the multiple files as operation target files; and a file operation section configured to perform the predetermined file operation on the operation target files. The predetermined file operation performed by the file operation apparatus includes, for example, a bulk file copy operation on the operation target files, a bulk file delete operation on the operation target files, a bulk file execution operation on the operation target files, a bulk file move operation on the operation target files, and a bulk file play operation on the operation target files.

According to the above file operation apparatus, it is possible to collectively select multiple files belonging to a user desired category and possible to collectively set the multiple files as an operation target. Accordingly, it is possible to save the effort of performing a complicated procedure, which may include: opening directories and displaying groups of files, each group belonging one directory; searching the group of files for desired files; and selecting the desired files as file operation target files. Therefore, according to the present embodiment, it is possible to collectively select file operation target files through a simple operation of selecting a desired category only.

The above described file operation apparatus may further include a list making section and a list information providing section. The list making section is configured to extract the category information items of the multiple files from the storage medium, and is configured to make a category information list associated with the prescribed categories of the multiple files. The list information providing section is configured to provide the category information list to the user. The category selection reception section receives the selection of the target category by receiving selection of an item in the category information list, the item being indicative of the target category.

According to the above configuration, the file operation apparatus enables a user to select the item in the category information list, the item being indicative of the target category. The file operation apparatus further enables a user to select the one or more of the multiple files as an operation target and to issue an instruction to collectively perform the predetermined file operation on the operation target, by selecting the item indicative of the target category only. It is thus possible to improve operability.

The above described file operation apparatus may be configured as follows. Each of the multiple files stored in the storage medium has one or more attributes and one or more categories classified according to the attributes. The list making section makes the category information list that is classified according to the attributes.

Music files are examples of the multiple files stored in the storage medium. Each music file typically contains additional information called tag information or tag data providing multiple category information items. Various attributes such as track tile, artist, album, genre and the like may be assigned to each music file. The category information item can represent a value or a name that corresponds to one attribute. For example, the category information item corresponding to the attribute “genre” is “classic”, “rock”, “jazz” or the like.

According to the above file operation apparatus, it is possible to provide a user with the category list information in which the prescribed categories of the multiple files are organized according to attributes. It is thereby possible to improve user convenience of selecting a desired category.

The above described file operation apparatus may be configured as follows. The file operation section specifies the operation target files through specifying locations of the operation target files on the storage medium by utilizing the file management information stored in the management area of the storage medium.

In a typical file system, the storage medium has the management area storing the file management information indicating a hierarchy structure for arranging and managing the multiple files, in addition to the data area storing the real data of the multiple files. In view of the above, the above described file operation apparatus may be configured such that the file operation section specifies the operation target files through specifying locations of the operation target files on the storage medium by utilizing the file management information stored in the management area of the storage medium.

The above described file operation apparatus may be configured such that the storage medium is one of a first storage medium externally-inserted in the subject file operation apparatus and a second storage medium externally-connected to the subject file operation apparatus.

The above described file operation apparatus may be configured such that the list information providing section provides the user with the category information list that is hierarchically structured according to the attributes and the categories.

The above described file operation apparatus may be configured such that the predetermined file operation includes a bulk file copy operation on the operation target files, a bulk file delete operation on the operation target files, a bulk file execution operation on the operation target files, a bulk file move operation on the operation target files, and a bulk file play operation on the operation target files.

The above described file operation apparatus may be connectable with an external storage device, so that the file operation section performs the bulk file copy operation on the operation target files to bulk-copy the operation target files from the storage medium to the external storage device. Alternatively, the above described file operation apparatus may further include an internal storage device, so that the file operation section performs the bulk file copy operation on the operation target files to bulk-copy the operation target files from the storage medium to the internal storage device.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A file operation apparatus for performing a predetermined file operation on a storage medium, wherein the storage medium stores therein multiple files, wherein the storage medium has a data area and a management area, wherein the data area stores therein a real data of each of the multiple files, wherein the management area stores therein information about a directory structure for organizing the multiple files, wherein the management area further stores therein file management information, wherein the real data of each of the multiple files contains a category information item defining a prescribed category of the each of the multiple files, wherein the prescribed category is independent of the directory structure, the file operation apparatus comprising:
a category selection reception section configured to receive selection of a target category from a user;
an operation target selection section configured to identify one or more of the multiple files whose prescribed category matches the target category from the multiples files based on the real data of each of the multiple files, and configured to select the identified one or more of the multiple files as operation target files; and
a file operation section configured to perform the predetermined file operation on the operation target files.

2. The file operation apparatus according to claim 1, further comprising:
a list making section configured to extract the category information items of the multiple files from the storage medium, and configured to make a category information list associated with the prescribed categories of the multiple files; and
a list information providing section configured to provide the category information list to the user,
wherein the category selection reception section receives the selection of the target category by receiving selection of an item in the category information list, the item being indicative of the target category.

3. The file operation apparatus according to claim 2, wherein:
each of the multiple files stored in the storage medium has one or more attributes and one or more categories classified according to the attributes; and
the list making section makes the category information list that is classified according to the attributes.

4. The file operation apparatus according to claim 1, wherein:
the file operation section specifies the operation target files through specifying locations of the operation target files on the storage medium by utilizing the file management information stored in the management area of the storage medium.

5. The file operation apparatus according to claim 1, wherein:
the storage medium is one of a first storage medium externally-inserted in the subject file operation apparatus and a second storage medium externally-connected to the subject file operation apparatus.

6. The file operation apparatus according to claim 3, wherein:
the list information providing section provides the user with the category information list that is hierarchically structured according to the attributes and the categories.

7. The file operation apparatus according to claim 1, wherein:
the predetermined file operation includes a bulk file copy operation on the operation target files, a bulk file delete operation on the operation target files, a bulk file execution operation on the operation target files, a bulk file move operation on the operation target files, and a bulk file play operation on the operation target files.

8. The file operation apparatus according to claim 7, wherein the file operation apparatus is connectable with an external storage device,
wherein the file operation section performs the bulk file copy operation on the operation target files to bulk-copy the operation target files from the storage medium to the external storage device.

9. The file operation apparatus according to claim 7, further comprising
an internal storage device,
wherein the file operation section performs the bulk file copy operation on the operation target files to bulk-copy the operation target files from the storage medium to the internal storage device.
